(19) United States
(12) Patent Application Publication
(10) Pub. No.: US 2005/0260970 A1
(43) Pub. Date: Nov. 24, 2005

(54) Method of and apparatus for operating a mobile terminal in response to an indication of charge level of battery of the terminal

(75) Inventors: Patrick Losquin, Lannion (FR); Jerome Descos, Louannec (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: FRANCE TELECOM SA, Paris (FR)

(21) Appl. No.: 11/132,420

(22) Filed: May 19, 2005

(30) Foreign Application Priority Data
May 19, 2004 (FR) 04 05497

(51) Int. Cl. H04B 1/16

(52) U.S. Cl. 455/343.5; 455/343.1

(57) ABSTRACT

The charge level of a battery of a mobile terminal is monitored. The terminal is switched to a previously defined economical operating mode from a normal active operating mode if (1) the charge level is less than or equal to a threshold value and (2) a user of the mobile terminal has agreed to switch to the economical operating mode.

### FIELD OF THE INVENTION

The present invention concerns a method of and apparatus for transmitting data by using at least one mobile terminal, the method and apparatus including monitoring the charge level of a mobile terminal battery.

### BACKGROUND ART

Methods intended to prolong the life of mobile terminal batteries are known from the documents described below.

In the document entitled “Reduction of energy consumption in on board electronics” (ENSSAT—University of Rennes LASTI—Signal Architecture Group), Olivier Sentieys reports that portable appliances are consuming their battery charge more and more quickly and that this phenomenon will increase. He therefore proposes to restrict this consumption by varying certain parameters of the mobile terminal and in particular by reducing the supply voltage, the effective capacity and the clock frequency.

In the document entitled “Optimisation of the energy consumption of signal processing applications and image on DSP” (S. Pignolo, E. Martin, N. Julien, B. Senn, B. Saget—LESTER—Univ. Bretagne Sud), the authors report that applications on board mobile terminals are developing more quickly than the associated hardware tools and that this difference is a source of overheating problems in batteries and limits the life of the batteries. They therefore propose to use different states of different applications on a mobile terminal in order for example to manage the energy consumption of the terminal by using “standby” modes or to adapt a supply voltage and/or an operating frequency of such a terminal in relation to a software task to be performed.

The documents described above present methods for reducing the energy consumed by various components of the terminal or for optimizing their consumption. These methods allow only a programmed management of the energy consumed by the mobile terminal and do not consider the requirements of the user, who quickly finds that it is impossible for him/her to use the terminal once a critical use threshold has been exceeded.

One aim of the invention is therefore to provide a new and improved method of and apparatus for managing the charge of a battery of a mobile terminal under the control of a user of the terminal.

### SUMMARY OF THE INVENTION

One aspect of the invention relates to a method of transmitting data by using a mobile terminal, the method including: monitoring the charge level of a mobile terminal battery; measuring the present value of a parameter representing the charge level; comparing the thus measured present value with a predetermined threshold value; and configuring the terminal in a previously defined economical operating mode if the current value is less than or equal to the threshold value.

The method according to the invention enables the user of the mobile terminal to be warned of any remaining low life of his battery and thus to control the life of the battery either by quickly using the remaining charge or by economically using the remaining energy as long as possible.

According to a first particular aspect of the invention, the method also includes the step of prior loading of configuration data defining the economical operating mode.

According to a second particular aspect of the invention, the method also includes the step of identifying an active operating mode in which the terminal is situated, intended to be executed prior to the configuration step.

The step of identifying the active operating mode ensures for the user a functioning of the terminal suitable to the terminal battery charge level.

According to a third particular aspect of the invention, the method also includes an alert step, during which at least one alert stimulus is emitted for the attention of the user in order to inform the user of a low battery charge level and a possible change of operating mode, the alert step being intended to be executed prior to the configuration step.

The user alert step warns the user of a low battery charge level of his terminal to enable the user to decide either (1) to leave the terminal in an active mode and to benefit from all the functions and services of his terminal or (2) to configure the terminal in an economical operating mode and thus to increase the operating life, in which case certain functions and services are no longer accessible.

According to a fourth particular aspect of the invention, the method also includes an alert verification step intended to give confirmation of the actual emission of at least one alert stimulus, the verification step being intended to be executed prior to the configuration step.

The verification step ensures that the operating mode of the mobile terminal will actually have been chosen, even tacitly by the user.

The invention also concerns a device for transmitting data by using at least one mobile terminal, the device including: a monitor for the charge level of a mobile terminal battery; a monitor for measuring the present value of a parameter representing the charge level; and a processor arrangement for configuring the terminal in a previously defined economical operating mode (a) if the present value is less than or equal to a threshold value, and (b) if, following the operation of an alert arrangement, a user of the mobile terminal has given his agreement for the processor arrangement to perform the configuring of the terminal.

According to a first particular apparatus aspect of the invention, the processor arrangement is arranged to load the configuration data defining the economical operating mode prior to the processor arrangement configuring the terminal.

According to a second particular apparatus aspect of the invention, the processor arrangement is arranged for identifying the active operating mode in which the terminal is situated prior to the processor arrangement configuring the terminal.

According to a third particular apparatus aspect of the invention, the processor arrangement is arranged for emitting at least one alert stimulus for the attention of the user in order to inform the user of a low battery charge level and a possible change in operating mode, the processor arrangement being arranged to be activated for enabling emission of the alert stimulus prior to the processor arrangement configuring the terminal.

According to a fourth particular apparatus of the invention, the processor arrangement is arranged to confirm the actual emission of at least one alert stimulus prior to the processor arrangement configuring the terminal.

Another aspect of the invention relates to a method of operating a mobile terminal having a battery comprising: deriving an indication of the charge level of the battery; and switching from a normal operating mode of the terminal to an economical operating mode of the terminal in response to the indication being equal to or less than a threshold value for the charge level and a user of the terminal signaling to the mobile terminal that the switching operation is to be performed.

The characteristics of the invention mentioned above, as well as others, will emerge more clearly from a reading of the following description of an example embodiment, the said description being given in relation to the accompanying drawings.

### BRIEF DESCRIPTION OF THE DRAWINGS

FIG. 1 is a flow diagram of operations performed by a processor arrangement of a mobile terminal according to a preferred embodiment of the invention, and

FIG. 2 is a block diagram of a terminal including a processor arrangement for performing the operations of FIG. 1 which the invention is implemented.

### DETAILED DESCRIPTION OF THE DRAWINGS

The method according to the invention is a method of transmitting data about the battery charge level of a mobile terminal. Such a mobile terminal can, for example, include a portable telephone, a portable computer, a personal assistant, etc. In a particular embodiment of the invention, the mobile terminal is a telephone of the “Smartphone” type including a processor arrangement using an operating system of the “Windows CE” type, the terms “Smartphone” and “Windows CE” being known to persons skilled in the art and being the subject of protection as trade marks.

The charge level of a mobile terminal battery is linked to the life of the battery before having to be recharged. Thus, when the charge level of a battery is close to a threshold value considered to be a value below which the battery can no longer enable the terminal to function correctly, the terminal can be configured in an operating mode that is as economical as possible, in which the terminal is no longer supplied with voltage.

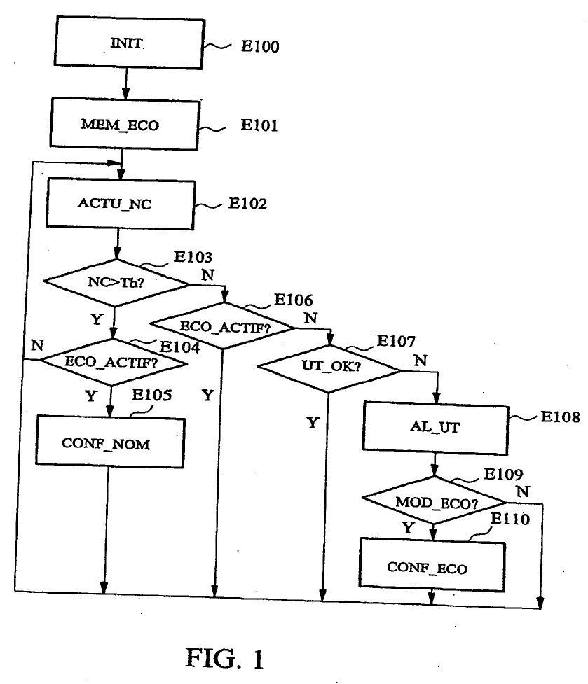

In the method illustrated in FIG. 1, the charge level of the terminal battery is monitored in the following manner during an initialization step E100 corresponding to the powering up of the mobile terminal, the latter is configured in a so-called initial operating mode, which is for example that in which the terminal was situated when the terminal was previously switched off.

During a storage step E101, the mobile terminal stores a profile defining an operating mode referred to as economical operating mode. This economical operating mode is an operating mode parameterized so that only functions considered to be essential to the user are activated, any other function being inhibited. Thus, if in a nominal operating mode, considered to be the normal habitual operating mode, functions 1 to 5 and services 1 to 5 are active, an economical operating mode may for example make provision to activate only functions 1, 2 and 4 and services 2 and 5, the other functions 3 and 5 and the other services 1, 3 and 4 then being inhibited.

Two economical operating modes are provided in this particular embodiment of the invention. A first economical operating mode is the default operating mode. In this default economical operating mode, parameters associated with the functions and services of the mobile terminal are established to enable only minimum functioning of the terminal. Thus, for a portable telephone, the functions and services will be reduced to the transmission and reception of calls and messages. In a particular embodiment of the invention, the services and functions inactivated in this default operating mode are for example screen saver, back lighting, audible keypad operation, ringing options, the loudspeaker, the listening volume, multimedia games and services, etc.

A second operating mode is referred to as the “personalizable” operating mode. In this personalizable operating mode, the active functions and services are chosen by the user. For example, for a portable telephone, the user can choose to activate his directory in addition to the call functions and services, despite this directory not being a service necessary for the sending or receiving of calls or messages. The user thus chooses the operating mode which he wishes to see used by the terminal as the economical operating mode.

In each of the possible economical operating modes, the active functions and services are also configured so as to reduce their consumption to the maximum extent. In addition, provision is made for the mobile terminal, in economical operating mode, to display the remaining use time before the switched-off configuration of the terminal.

In a particular embodiment of the invention, the functions and services of the default economical operating mode and of the personalizable operating mode are listed in a parameter file recorded permanently in a register base of the mobile terminal. The state of the functions and services of this file can easily be modified by using the terminal interface.

During a measuring step E102, the mobile terminal updates the battery charge level by measuring the present value NC of a parameter representing the charge level. Updating the charge level makes it possible to have an assessment of the remaining life of the mobile terminal battery.

The present value of the charge level thus measured is compared with a predetermined threshold value Th during a comparison step E103. This threshold value is preferably situated at an interval of a critical threshold value, the critical threshold value being approximately zero. The threshold value Th is chosen so that the corresponding battery charge can provide an economical operating mode for a given time period.

If it appears, at the end of the comparison step E103, that the present value NC of the charge level is greater than or equal to the threshold value Th, the following step is a first identification step E104. Otherwise, the following step is a second identification step E106.

During the first identification step E104, the active operating mode is identified. If the active operating mode is not the economical operating mode, that is to say if for example the operating mode is the nominal operating mode, then the method makes provision for returning to the measuring step E102 without acting on the active operating mode. On the other hand, if the active operating mode is the economical operating mode, the present value NC of the battery charge not justifying this unnecessarily restrictive operating mode, the terminal is configured during a configuration step E105 in a nominal operating mode. The method then makes provision for returning to the measuring step E102 without acting on the active operating mode.

During the second identification step E106, the active operating mode is also identified. If the active operating mode is the economical operating mode, then the method makes provision for returning to the measuring step E102 without performing any other action. Otherwise, during a verification step E107, the method provides for checking whether the user has been alerted with regard to the low battery charge level. If the user has already been alerted, the method provides for returning to the measuring step E102 without any other action. Otherwise, during an alert step E108, an alert in the form of an alert stimulus is transmitted by the mobile terminal to the user in order to inform him of a low battery charge level and a possible change in operating mode. This stimulus may, for example, be an optical signal, a message, etc. If the user decides to change to economical operating mode, the economical operating mode then becomes the active operating mode. If the user does not accept the change in operating mode, the terminal is maintained in nominal operating mode. The method then makes provision, whatever the operating mode chosen, for returning to the measuring step E102 so as to keep the user informed of the charge value remaining in the battery before the terminal is switched off.

In general terms, the method preferably interferes as little as possible with the general functioning of the terminal.

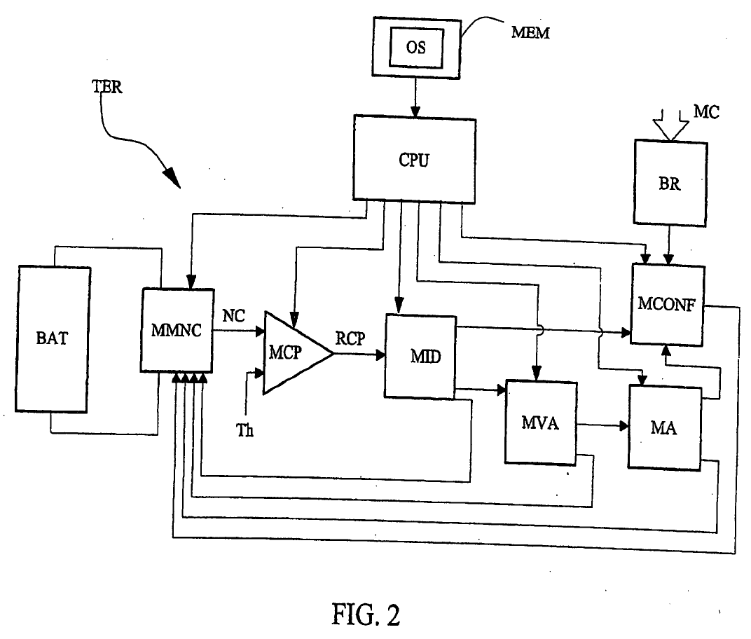

The method of FIG. 1 is preferably performed by a data transmission device included in a terminal TER as illustrated in FIG. 2. In this particular embodiment of the invention, the functioning of this data transmission device is managed by an operating system OS in a processor arrangement including central processor unit CPU and memory MEM. Operating system OS controls central unit CPU. Operating system OS is recorded permanently in the memory MEM included in or within the mobile terminal TER. Under the control of the operating system OS, the central unit CPU controls activations and deactivations of measuring device MMNC, comparison module MCP, identification module MID, alert verification module MVA, alert module MA and configuration module MCONF by means of activation signals ENM, ENC, ENI, ENV, ENA and ENO respectively. Typically, modules MCP, MID, MVA, MA and MCONF are included in central processor unit CPU.

Such a device comprises measuring device MMNC for measuring a present value NC of a parameter representing the charge level of a battery BAT. Measuring device MMNC is, for example, able to measure a voltage delivered by the battery BAT; the instantaneous value of the voltage of battery BAT constitutes the present value NC. This present value NC is compared by comparison module MCP with a predefined threshold value Th. Comparison module MCP can for example include an operational amplifier intended to deliver a comparison signal RCP whose value represents the result of the comparison or be a module in central processor CPU that responds to an analog to digital converter of the CPU, in turn responsive to the voltage of battery BAT. In either case, the comparison module is considered part of a processor arrangement. This signal RCP is received by identification module MID able to determine the active operating mode of the terminal, whatever the value of the comparison signal RCP.

If, at the end of the previous determination, the identification module MID indicates that the active operating mode is an economical operating mode and that in addition the present value NC is greater than the threshold value Th, configuration module MCONF configures the terminal in nominal operating mode. Configuration module MCONF communicates with a register base BR provided for storing the data necessary for configuring the operating modes and in particular economical operating modes contributed by configuration data loading module MC.

If the present value NC is greater than the threshold value Th, but the active operating mode is not an economical operating mode, then no other module is activated. Likewise, if the present value NC is less than the threshold value Th and the active operating mode is an economical operating mode, then no other module is activated. On the other hand, if the present value NC is equal to or below the threshold value Th and the active operating mode is not an economical operating mode, then alert verification module MVA is activated. If the alert has already been given no other module is activated subsequently, otherwise the verification module MVA activates alert module MA. Alert module MA warns the user of the terminal that the battery BAT has a low present charge level value NC and proposes or suggests to the user that the terminal be switched from the active operating mode to a configuration in the economical operating mode.

If the user decides to configure the terminal in an economical operating mode, the alert module activates the configuration module MCONF, which configures the terminal in a predefined economical operating mode. If the user chooses to remain in the active operating mode, no module is activated accordingly.

1. Method of transmitting data by using at least one mobile terminal, said method including:
measuring the present value of a parameter representing the charge level of a battery of the mobile terminal; and
configuring the terminal in a previously defined economical operating mode if (a) the present value is less than or equal to a threshold value and (b) following the execution of an alert step, a user of the mobile terminal has given his agreement for this configuration step to be executed.

2. Data transmission method according to claim 1, further including loading configuration data defining the economical operation mode prior to performing the configuring step.

3. Data transmission method according to claim 1, further including identifying an active operating mode in which the terminal is situated prior to performing the configuring step.

4. Data transmission method according to claim 1, wherein the alert step includes emitting at least one alert stimulus for the attention of the user in order to inform the user of a low battery charge level and a possible change in operating mode, the said alert step being performed prior to performing the configuring step.

5. Data transmission step according to claim 4, further including performing an alert verification step to confirm the actual emission of at least one alert stimulus, the verification step being performed prior to the configuration step.

6. Device for transmitting data indicative of the charge level of a battery of a mobile terminal, including:
a monitor for measuring the present value of a parameter representing the charge level; and
a processor arrangement for configuring the terminal in a previously defined economical operating mode (a) if the present value is less than or equal to the threshold value and (b) if, following the operation of an alert arrangement, a user of the mobile terminal has given his agreement for the processor arrangement to perform the configuring of the terminal.

7. Data transmission device according to claim 6, wherein the processor arrangement is arranged to load the configuration data defining the economical operating mode prior to the processor arrangement configuring the terminal.

8. Data transmission device according to claim 6, wherein the processor arrangement is arranged for identifying the active operating mode in which the terminal is situated prior to the processor arrangement configuring the terminal.

9. Data transmission device according to claim 6, wherein the processor arrangement is arranged for emitting at least one alert stimulus for the attention of the user in order to inform the user of a low battery charge level and a possible change in operating mode, the processor arrangement being arranged to be activated for enabling emission of the alert stimulus prior to the processor arrangement configuring the terminal.

10. Data transmission device according to claim 9, wherein the processor arrangement is arranged to confirm the actual emission of at least one alert stimulus prior to the processor arrangement configuring the terminal.

11. A method of operating a mobile terminal having a battery comprising:
deriving an indication of the charge level of the battery; and
switching from a normal operating mode of the terminal to an economical operating mode of the terminal in response to the indication being equal to or less than a threshold value for the charge level and a user of the terminal signaling to the mobile terminal that the switching operation is to be performed.
